(19) United States
(12) Patent Application Publication
(10) Pub. No.: US 2006/0168431 A1
(43) Pub. Date: Jul. 27, 2006

(54) Method and apparatus for jump delay slot control in a pipelined processor

(76) Inventors: Peter Warnes, London (GB); Carl Graham, London (GB)

Correspondence Address: GAZDZINSKI & ASSOCIATES, 11440 WEST BERNARDO COURT, SUITE 375, SAN DIEGO, CA, 92127, US

(21) Appl. No.: 11/387,258

(22) Filed: Mar. 22, 2006

Related U.S. Application Data
(63) Continuation of application No. 09/523,877, filed on Mar. 13, 2000.
(60) Provisional application No. 60/134,253, filed on May 13, 1999.
(60) Provisional application No. 60/104,271, filed on Oct. 14, 1998.

(51) Int. Cl. G06F 9/44

(52) U.S. Cl. 712/233

(57) ABSTRACT

An improved method and apparatus for implementing instructions in a pipelined central processing unit (CPU) or user-customizable microprocessor. In a first aspect of the invention, an improved method of controlling branching and the execution of instructions within the pipeline is disclosed. In one embodiment, the method comprises defining three discrete delay slot modes within program jump instructions; these delay slot modes specify the execution of subsequent instructions or the stalling of the pipeline as desired by the programmer. In a second aspect of the invention, a method of synthesizing a processor design incorporating the aforementioned modes is disclosed. Exemplary gate logic synthesized using the aforementioned methods, and a computer system capable of implementing these methods, are also described.

This application claims priority to U.S. Provisional Patent Application Ser. No. 60/134,253 filed May 13, 1999, entitled “Method And Apparatus For Synthesizing And Implementing Integrated Circuit Designs,” and to co-pending U.S. patent application Ser. No. 09/418,663 filed Oct. 14, 1999, entitled “Method And Apparatus For Managing The Configuration And Functionality Of A Semiconductor Design,” which claims priority to U.S. Provisional Patent Application Ser. No. 60/104,271 filed Oct. 14, 1998, of the same title.

### BACKGROUND OF THE INVENTION

1. Field of the Invention

The present invention relates to the field of integrated circuit design, specifically to the use of a hardware description language (HDL) for implementing instructions in a pipelined central processing unit (CPU) or user-customizable microprocessor.

2. Description of Related Technology

RISC (or reduced instruction set computer) processors are well known in the computing arts. RISC processors generally have the fundamental characteristic of utilizing a substantially reduced instruction set as compared to non-RISC (commonly known as “CISC”) processors. Typically, RISC processor machine instructions are not all micro-coded, but rather may be executed immediately without decoding, thereby affording significant economies in terms of processing speed. This “streamlined” instruction handling capability furthermore allows greater simplicity in the design of the processor (as compared to non-RISC devices), thereby allowing smaller silicon and reduced cost of fabrication.

RISC processors are also typically characterized by (i) load/store memory architecture (i.e., only the load and store instructions have access to memory; other instructions operate via internal registers within the processor); (ii) unity of processor and compiler; and (iii) pipelining.

Pipelining is a technique for increasing the performance of processor by dividing the sequence of operations within the processor into segments which are effectively executed in parallel when possible. In the typical pipelined processor, the arithmetic units associated with processor arithmetic operations (such as ADD, MULTIPLY, DIVIDE, etc.) are usually “segmented”, so that a specific portion of the operation is performed in a given segment of the unit during any clock cycle. FIG. 1 illustrates a typical processor architecture having such segmented arithmetic units. Hence, these units can operate on the results of a different calculation at any given clock cycle. As an example, in the first clock cycle two numbers A and B are fed to the multiplier unit 10 and partially processed by the first segment 12 of the unit. In the second clock cycle, the partial results from multiplying A and B are passed to the second segment 14 while the first segment 12 receives two new numbers (say C and D) to start processing. The net result is that after an initial startup period, one multiplication operation is performed by the arithmetic unit 10 every clock cycle.

The depth of the pipeline may vary from one architecture to another. In the present context, the term “depth” refers to the number of discrete stages present in the pipeline. In general, a pipeline with more stages executes programs faster but may be more difficult to program if the pipeline effects are visible to the programmer. Most pipelined processors are either three stage (instruction fetch, decode, and execute) or four stages (such as instruction fetch, decode, operand fetch, and execute, or alternatively instruction fetch, decode/operand fetch, execute, and writeback), although more or less stages may be used.

Interlocks are necessary with pipelined architectures generally to address, inter alia, the case where a following instruction (n+1) in an earlier pipeline stage needs the result of the instruction n from a later stage. A simple solution to the aforementioned problem is to delay the operand calculation in the instruction decoding phase by one or more clock cycles. “Scoreboarding” may be used, wherein a bit is attached to each processor register to act as an indicator of the register content. Alternatively, NOPs (no-operation opcodes) may be inserted in the code so as to delay the appropriate pipeline stage when desired. This later approach has been referred to as “software interlocking” and has the disadvantage of increasing the code size and complexity of programs that employ instructions that require interlocking.

Another important consideration in processor design is program branching or “jumps”. All processors support some type of branching instructions. Simply stated, branching refers to the condition where program flow is interrupted or altered. Other operations such as loop setup and subroutine call instructions also interrupt or alter program flow in a similar fashion. The term “jump delay slot” is often used to refer to the slot within a pipeline subsequent to a branching or jump instruction being decoded. Branching may be conditional (i.e., based on the truth or value of one or more parameters) or unconditional. It may also be absolute (e.g., based on an absolute memory address), or relative (e.g., based on relative addresses and independent of any particular memory address).

Branching can have a profound effect on pipelined systems. By the time a branch instruction is inserted and decoded by the processor's instruction decode stage (indicating that the processor must begin executing a different address), the next instruction word in the instruction sequence has been fetched and inserted into the pipeline. One solution to this problem is to purge the fetched instruction word and halt or stall further fetch operations until the branch instruction has been executed, as illustrated in FIG. 2. This approach, however, by necessity results in the execution of the branch instruction in several instruction cycles, this number typically being between one and the depth of the pipeline employed in the processor design. This result is deleterious to processor speed and efficiency, since other operations can not be conducted by the processor during this period.

Alternatively, a delayed branch approach may be employed. In this approach, the pipeline is not purged when a branch instruction reaches the decode stage, but rather subsequent instructions present in the earlier stages of the pipeline are executed normally before the branch is executed. Hence, the branch appears to be delayed by the number of instruction cycles necessary to execute all subsequent instructions in the pipeline at the time the branch instruction is decoded. This approach increases the efficiency of the pipeline as compared to multi-cycle branching described above, yet also complexity (and ease of understanding by the programmer) of the underlying code.

Based on the foregoing, processor designers and programmers must carefully weigh the tradeoffs associated with utilizing either the delayed or multi-cycle branching approaches of the prior art. What is needed is an improved approach to branching/jumping which overcomes or mitigates these tradeoffs while providing the additional flexibility. Furthermore, as more pipeline stages (and even multiple multi-stage pipelines) are added to processor designs, the benefits of improved and simplified branching and instruction execution within the processor increased manifold. Additionally, the ability to readily synthesize such improved pipelined processor designs in an application-specific manner, and using available synthesis tools, is of significant utility to the designer and programmer.

### SUMMARY OF THE INVENTION

The present invention satisfies the aforementioned needs by providing an improved method and apparatus for executing instructions within a digital processor architecture.

In a first aspect of the invention, an improved method of managing branching and instruction execution within a pipelined processor is disclosed. In one exemplary embodiment, three discrete delay slot modes are implemented using predetermined bits of the instruction word. These three modes include: (i) execution of a delay slot instruction under all circumstances; (ii) the execution of a delay slot instruction only if a jump is taken, and (iii) a pipeline stall or bubble in place of an instruction execution if a jump is taken. A pipeline bubble is analogous to a NOP no-operation instruction in that it is an instruction which flows through the pipeline without performing any operation. It will typically be an instruction which has been ‘killed’ after having been fetched into the pipeline. The availability of these three modes provides the programmer with additional flexibility in jump delay slot control using existing branch or similar instructions. Unconstrained and constrained exemplary synthesized logic implementing the aforementioned delay slot method is also disclosed.

In a second aspect of the invention, an improved method of synthesizing the design of an integrated circuit incorporating the aforementioned jump delay slot method is disclosed. In one exemplary embodiment, the method comprises obtaining user input regarding the design configuration; creating customized HDL functional blocks based on the user's input and existing library of functions; determining the design hierarchy based on the user's input and the library and generating a hierarchy file, new library file, and makefile; running the makefile to create the structural HDL and scripts; running the generated scripts to create a makefile for the simulator and a synthesis script; and synthesizing the design based on the generated design and synthesis script.

In a third aspect of the invention, an improved computer program useful for synthesizing processor designs and embodying the aforementioned method is disclosed. In one exemplary embodiment, the computer program comprises an object code representation stored on the magnetic storage device of a microcomputer, and adapted to run on the central processing unit thereof. The computer program further comprises an interactive, menu-driven graphical user interface (GUI), thereby facilitating ease of use.

In a fourth aspect of the invention, an improved apparatus for running the aforementioned computer program used for synthesizing logic associated with pipelined processors is disclosed. In one exemplary embodiment, the system comprises a stand-alone microcomputer system having a display, central processing unit, data storage device(s), and input device.

In a fifth aspect of the invention, an improved processor architecture utilizing the foregoing jump delay slot methodology and constrained/unconstrained synthesized logic is disclosed. In one exemplary embodiment, the processor comprises a reduced instruction set computer (RISC) having a three stage pipeline comprising instruction fetch, decode, and execute stages which are controlled in part by the aforementioned jump delay slot methodology.

### BRIEF DESCRIPTION OF THE DRAWINGS

FIG. 1 is block diagram of a typical prior art processor architecture employing “segmented” arithmetic units.

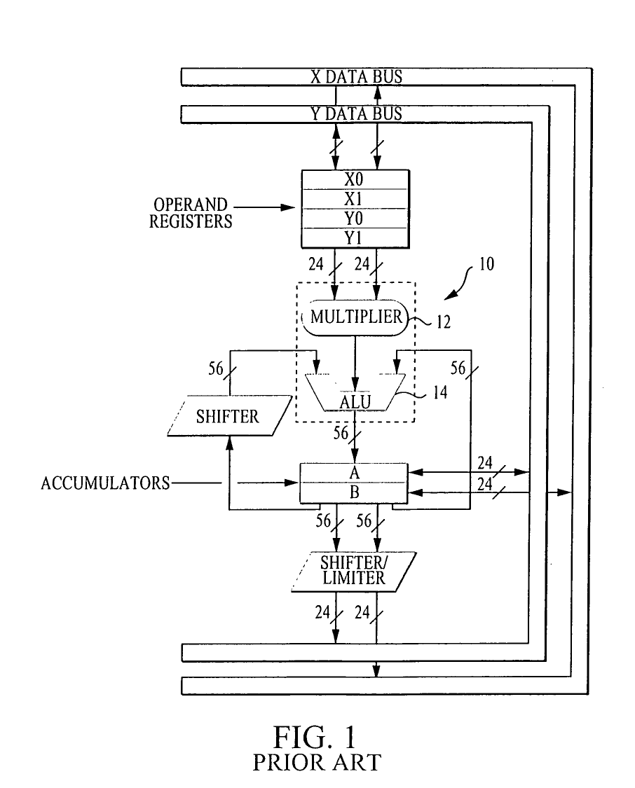

FIG. 2 illustrates graphically the operation of a four stage pipelined processor undergoing a multi-cycle branch operation.

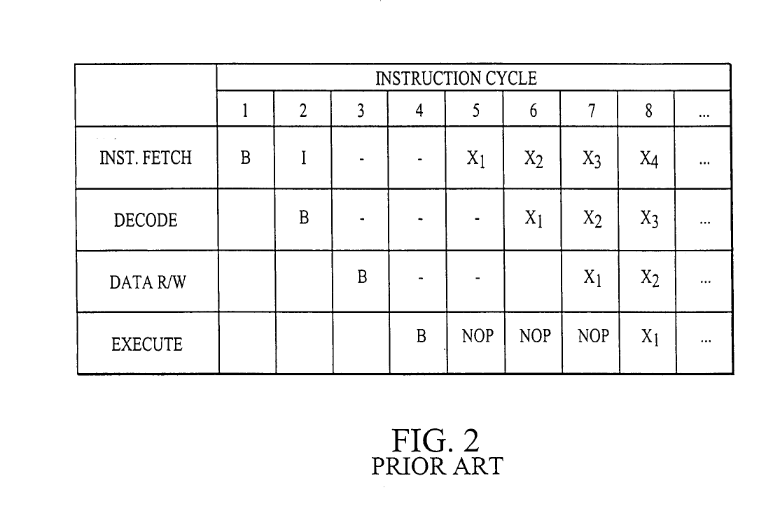

FIG. 3 is a logical flow diagram illustrating the generalized methodology of controlling jump delay slot modes within a pipelined processor according to the present invention.

FIG. 3a is a logical flow diagram illustrating one exemplary embodiment of the method of executing the designated jump delay slot mode of FIG. 3

FIG. 4 is a logical flow diagram illustrating the generalized methodology of synthesizing processor logic which incorporates jump delay slot modes according to the present invention.

FIG. 5 is a schematic diagram illustrating a first embodiment of synthesized logic (unconstrained) used to implement the jump delay slot modes of the present invention.

FIG. 6 is a schematic diagram illustrating a second embodiment of synthesized logic (constrained) used to implement the jump delay slot modes of the present invention.

FIG. 7 is a block diagram of a pipelined processor design incorporating jump delay slot modes according to the present invention.

FIG. 8 is a functional block diagram of one exemplary embodiment of a computer system useful for synthesizing the logic apparatus of FIGS. 5-6.

### DETAILED DESCRIPTION OF THE INVENTION

Reference is now made to the drawings wherein like numerals refer to like parts throughout.

As used herein, the term “processor” is meant to include any integrated circuit or other electronic device capable of performing an operation on at least one instruction word including, without limitation, reduced instruction set core (RISC) processors such as the ARC user-configurable core manufactured by the Assignee hereof, central processing units (CPUs), and digital signal processors (DSPs). The hardware of such devices may be integrated onto a single piece of silicon (“die”), or distributed among two or more die. Furthermore, various functional aspects of the processor may be implemented solely as software or firmware associated with the processor.

Additionally, it will be recognized by those of ordinary skill in the art that the term “stage” as used herein refers to various successive stages within a pipelined processor; i.e., stage 1 refers to the first pipelined stage, stage 2 to the second pipelined stage, and so forth.

It is also noted that while the following description is cast in terms of VHSIC hardware description language (VHDL), other hardware description languages such as Verilog® may be used to describe various embodiments of the invention with equal success. Furthermore, while an exemplary Synopsys® synthesis engine such as the Design Compiler 1999.05 (DC99) is used to synthesize the various embodiments set forth herein, other synthesis engines such as Buildgates® available from, inter alia, Cadence Design Systems, Inc., may be used. IEEE std. 1076.3-1997, IEEE Standard VHDL Synthesis Packages, describe an industry-accepted language for specifying a Hardware Definition Language-based design and the synthesis capabilities that may be expected to be available to one of ordinary skill in the art.

Lastly, it will be recognized that while the following description illustrates specific embodiments of logic synthesized by the Assignee hereof using the aforementioned synthesis engine and VHSIC hardware description language, such specific embodiments being constrained in different ways, these embodiments are only exemplary and illustrative of the design process of the present invention. Furthermore, while a 1.0 um process was specified for these embodiments, other fabrication processes (such as 0.35 um or 0.18 um) may conceivably be used in conjunction with the invention disclosed herein.

Jump Delay Slot Modes

The improved method of controlling jump delay slots and their encoding within a processor according to the present invention is now described.

The present invention generally comprises a plurality of different “jump modes” or modifiers. These modifiers control the operation of the processor during jumping; specifically, the execution of instructions subsequent to or in an earlier pipeline stage than that of the jump instruction itself. Collectively, these modifiers provide the programmer with benefits not afforded by either the multi-cycle or delayed branch approaches in isolation since the programmer can arrange the program code so that the pipeline operates in the desired fashion during such jump or branching operations.

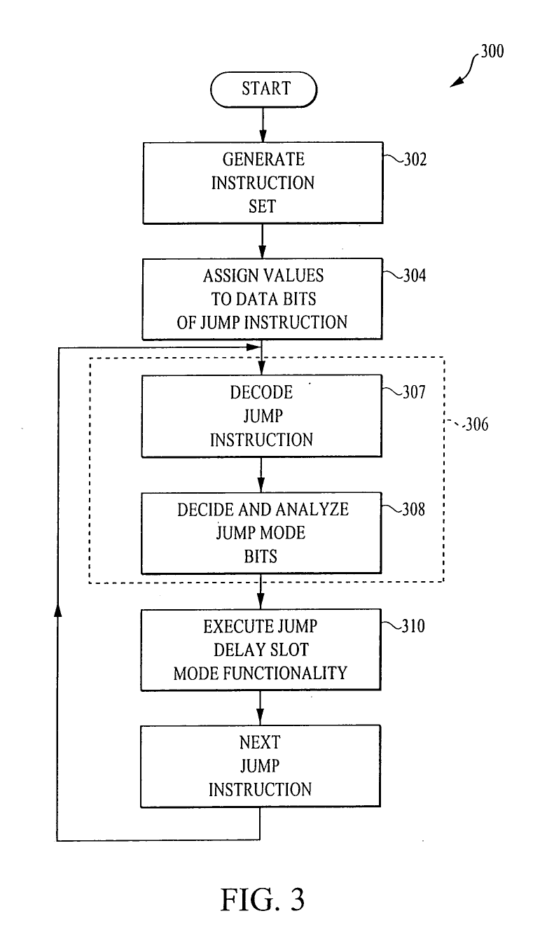

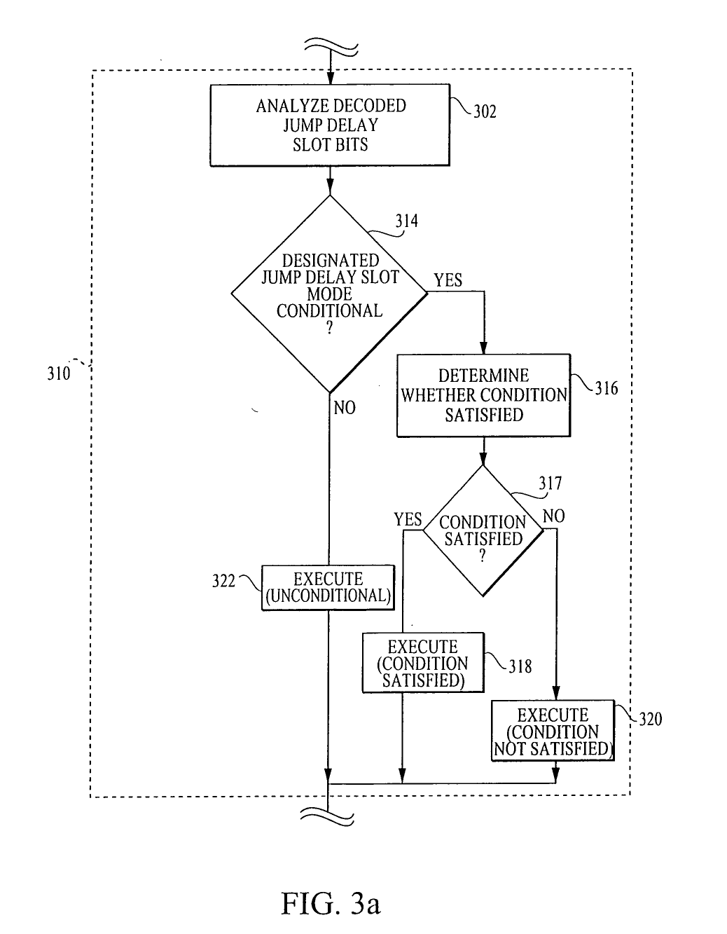

Referring now to FIG. 3, the generalized method 300 of controlling the execution of instructions during jumping within a pipe lined processor according to the present invention is described. First, in step 302, a program adapted to run on the processor and comprising a plurality of instruction “words” is provided. Each instruction word in the program is represented by and comprises a plurality of data bits, and at least one of the instruction words comprises a jump instruction. In the present context, the term ‘instruction set’ is used to describe the complete set of every possible instruction which could be executed on the processor, and the term ‘program’ is used to describe a specific sequence of instructions selected from the instruction set of the processor to achieve a specific purpose. As used herein, the term “jump” refers to any branch, jump, loop setup, or call instructions, although other instructions requiring a change in the flow of the instruction processing of the processor may conceivably be used in conjunction with the disclosed invention.

Next, in step 304, one of a plurality of predetermined values is assigned to at least one of the data bits of the jump instruction. In one embodiment, two data bits of the jump instruction word are designated to carry the jump delay slot mode information as described below with reference to Table 1. With the allowable binary states of “0” and “1” for each of the two bits, 2² or 4 unique combinations may be formed, each designating a different jump delay slot mode. It will be recognized, however, that any different number of unique (or non-unique) modes may be designated by using more or less data bits, or even a different numerical base employed if desired.

Next, in step 306, the at least one jump instruction containing the jump delay slot mode information is decoded by the processor. Methods and apparatus useful for instruction decoding are well known in the computer arts, and accordingly will not be described further herein. It is noted, however, that in contrast to prior art methods of decoding instructions, decoding of jump instructions within the instruction set of the present invention includes not only decoding of the instruction itself (step 307), but also decoding and analysis of the designated jump delay slot mode data bits (step 308) as previously described.

In step 310, the designated jump delay slot mode is executed, according to the functionality specified by the programmer in step 304.

FIG. 3a illustrates one exemplary embodiment of the method of executing the designated jump delay slot mode per step 310 of FIG. 3. In a first step 312, the data bits designated in step 304 to carry the delay slot mode information are read to determine the jump delay slot mode selected within the instruction being decoded. Next, in step 314, the selected delay slot mode is analyzed to determine if it is conditional (i.e., dependent upon another parameter such as whether or not a jump to another program address is taken). If the selected mode is conditional, the status of the parameter is analyzed in steps 316 and 317 to determine the “truth” thereof. If the condition is true, the required actions for a true condition are executed per step 318. If the condition is not true, the required actions for a false condition are taken (or alternatively no action is taken) per step 320. If the selected mode is not conditional on any parameter, the action required by that mode (such as execution of a subsequent instruction within the pipeline, or a pipeline stall) is executed in step 322.

In one exemplary embodiment of the foregoing method 300, the following three jump modifiers (delay slot modes) are defined:
(1) ND (“No Delayed Instruction Slot”)—Only executes the next instruction in pipeline when not jumping; if jumping, one cycle pipeline stall or bubble inserted
(2) D (“Delayed Instruction Slot”)—Always execute the next instruction regardless of jump status
(3) JD (“Jump Delayed Instruction Slot”)—Only execute the next instruction when jumping; if not jumping, one cycle pipeline stall or bubble inserted
   The first mode (1) provides a pipeline “stall” of one or more cycles in place of an instruction execution if a jump is taken. The second mode (2) provides for execution of a delay slot instruction (i.e., the instruction present in the slot following the jump instruction after decode under all circumstances. The third mode (3) provides for the execution of a delay slot instruction only if a jump is taken. While the following discussion is cast in terms of these three modes, it will be recognized that not all three modes are required to be used collectively or within the same instruction set, and further that other additional delay modes with different functionality may be added to the instruction set to further enhance programming flexibility and control.

The availability of the foregoing three distinct modes provides the programmer with additional flexibility in jump delay slot control, due in part to the ability to customize the instruction set while not being limited to pure multi-cycle or delayed branching approaches as previously described. Specifically, by inserting the appropriate jump delay mode codes within certain instructions within the program, the programmer may obtain beneficial characteristics of both the multi-cycle and delay branching approaches within one processor and one instruction set.

Table 1 illustrates the jump delay mode coding associated with the aforementioned three delay slot modes. In the illustrated embodiment, two binary data bits of the processor instruction word (IW) are used to indicate each one of the three delay slot modes ND, D, and JD:

TABLE 1

| IW Bits | Syntax | Mode |
|---|---|---|
| 00 | .nd | No Delay slot instruction execution if jump taken - |
| | | one cycle pipeline stall or bubble instead. |
| 01 | .d | Delay slot instruction always executed. |
| 10 | .jd | Delay slot instruction executed only if Jump is taken |
| 11 | | (Reserved) |

Table 2 is a truth table derived from the defined jump delay slot modes of Table 1:

TABLE 2

| | Condition Truth | |
|---|---|---|
| Jump Delay | | |
| Slot Mode | Jump Taken | No Jump Taken |
| .nd | One cycle stall or bubble | Delay slot instruction |
| | | execution |
| .d | Delay slot instruction execution | Delay slot instruction |
| | | execution |
| .jd | Delay slot instruction execution | No delay slot |
| | | instruction execution |

The following assembly language code illustrates examples of the syntax and operation of each of the respective jump delay slot modes of Table 1 using a conditional branch instruction (beq) to program location ‘target’ followed by a mathematical (add) instruction:

| | | | |
|---|---|---|---|
| (1) | beq.nd | target | ; |
| | add | r1,r1,1 | ; “add” not executed if jump taken |
| (2) | beq.d | target ; | |
| | add | r1,r1,1 | ; “add” always executed |
| (3) | beq.jd | target | : |
| | add | r1,r1,1 | ; “add” executed only if jump taken |

The fourth mode (“11”) of Table 1 may be used for other jump mode or non jump mode functions as desired, thereby affording the programmer even further flexibility Additionally, while two bits of the instruction word are illustrated in the embodiment of Table 1, it will be appreciated that other numbers and arrangements of bits (including their position within the instruction word and their syntax) may conceivably be used. For example, three non-contiguous bits could be used to represent up to eight separate jump delay slot modes.

Table 3 illustrates a second embodiment of the jump delay slot modes of the invention utilizing five jump delay slot modes (four plus one reserved) based on three data bits within the IW:

TABLE 3

| IW Bits | Syntax | Mode |
|---|---|---|
| 000 | | (Reserved) |
| 001 | .jd | Delay slot instruction executed only if Jump is taken |
| 010 | .d | Delay slot instruction always executed. |
| 011 | .nd1 | No Delay slot instruction execution if jump taken - |
| | | one cycle pipeline stall instead. |
| 100 | | (Reserved) |
| 101 | | (Reserved) |
| 110 | | (Reserved) |
| 111 | .nd2 | No Delay slot instruction execution if jump taken - |
| | | two cycle pipeline stall instead. |

In the illustrated embodiment(s), jump instructions present within the instruction set may stop execution of (i.e. “kill”) other instruction types, depending on two factors: (i) the selected delay slot mode, and (ii) whether the jump instruction's condition is true. The following four instructions illustrate the foregoing principles in the context of VHDL coding associated with Applicant's ARC RISC processor:

| 1. | Regular jump instruction: | | | |
|---|---|---|---|---|
| | ip2rjmp | <= ‘1’ WHEN ip2iv = ‘1’ | AND | (ip2i = obcc |
| | | | OR | ip2i = oblcc |
| | | | OR | ip2i = ojcc) ELSE |
| | | ‘0’; | | |
| 2. | Loop setup instruction: | | | |
| | ip21pcc | <= ‘1’ WHEN ip2iv = ‘1’ | AND | (ip2i = olpcc) ELSE |
| | | ‘0’; | | |

| | |
|---|---|
| 3. | Jumping/nojump signals: |

ip2jumping
<= (ip2rjmp AND ip2condtrue) OR (ip21pcc AND NOT ip2condtrue);
ip2nojump
<= (ip2rjmp AND NOT ip2condtrue) OR (ip21pcc AND ip2condtrue);

| | |
|---|---|
| 4. | “Kill” signal: |

| | | | |
|---|---|---|---|
| ip2killnext<= | ‘1’ | WHEN | ((ip2dd = dmk) AND ip2bch = ‘1’) |
| | | OR | ((ip2dd = dmnd) AND ip2jumping = ‘1’) |
| | | OR | ((ip2dd = dmjd) AND ip2nojump = ‘1’) |

ELSE

‘0’;

p2killnext <= ip2killnext;

It is noted that the ip2killnext instruction of the illustrated embodiment includes p2iv (pipeline stage 2 instruction valid signal) and a full decode for a jump operation, so that it can be used within the pipeline control logic (“pipectl”) without any further decode apart from en2 (pipeline stage 2 enabled/stalled signal). This feature reduces decode delays and permits faster instruction execution. While the decode technique used in this example results in the foregoing operational benefits, it will be recognized that this technique is not essential to the practice of the present invention.

Appendix A illustrates one exemplary embodiment of the VHDL used for synthesis of the foregoing jump delay slot modes of the present invention.

Appendix B provides an exemplary synthesis script for delay slot synthesis using the Synopsys® synthesis engine.

It is also noted that the methods and apparatus of the present invention may be used in conjunction with (either alone or collectively) other methods of pipeline control and interlock including, inter alia, those disclosed in Applicant's co-pending U.S. patent application entitled “Method And Apparatus For Jump Control In A Pipelined Processor,” as well as those disclosed in Applicant's co-pending U.S. patent application entitled “Method And Apparatus For Processor Pipeline Segmentation and Reassembly,” both filed contemporaneously herewith, both being incorporated by reference herein in their entirety. Furthermore, various register encoding schemes, such as the “loose” register encoding described in Applicant's co-pending U.S. patent application entitled “Method and Appatatus for Loose Register Encoding Within a Pipelined Processor” filed contemporaneously herewith and incorporated by reference in its entirety herein, may be used in conjunction with the jump delay slot invention described herein.

Method of Synthesizing

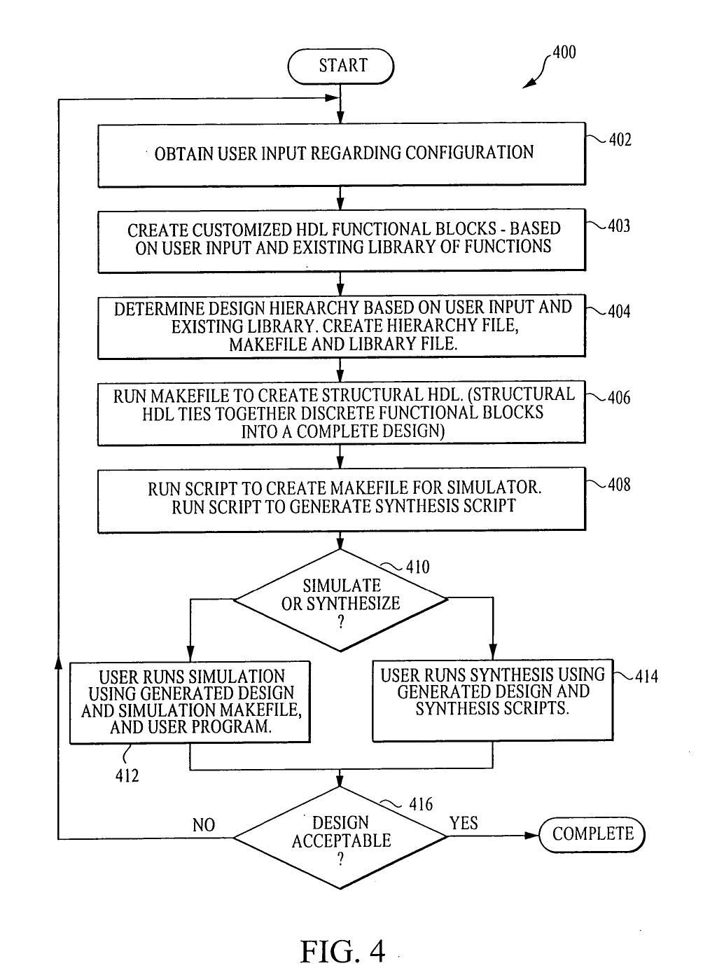

Referring now to FIG. 4, the method 400 of synthesizing logic incorporating the jump delay slot mode functionality previously discussed is described. The generalized method of synthesizing integrated circuit logic having a user-customized (i.e., “soft”) instruction set is disclosed in Applicant's co-pending U.S. patent application Ser. No. 09/418,663 entitled “Method And Apparatus For Managing The Configuration And Functionality Of A Semiconductor Design” filed Oct. 14, 1999, which is incorporated herein by reference in its entirety.

While the following description is presented in terms of an algorithm or computer program running on a microcomputer or other similar processing device, it can be appreciated that other hardware environments (including minicomputers, workstations, networked computers, “supercomputers”, and mainframes) may be used to practice the method. Additionally, one or more portions of the computer program may be embodied in hardware or firmware as opposed to software if desired, such alternate embodiments being well within the skill of the computer artisan.

Initially, user input is obtained regarding the design configuration in the first step 402. Specifically, desired modules or functions for the design are selected by the user, and instructions relating to the design are added, subtracted, or generated as necessary. For example, in signal processing applications, it is often advantageous for CPUs to include a single “multiply and accumulate” (MAC) instruction. In the present invention, the instruction set of the synthesized design is modified so as to incorporate the foregoing jump delay slot modes (or another comparable jump delay slot control architecture) therein. Specifically, in the present embodiment, one of a plurality of predetermined values indicating the designated jump delay slot mode is represented by two data bits of the jump instruction word as described above with reference to Table 1. The technology library location for each VHDL file is also defined by the user in step 402. The technology library files in the present invention store all of the information related to cells necessary for the synthesis process, including for example logical function, input/output timing, and any associated constraints. In the present invention, each user can define his/her own library name and location(s), thereby adding further flexibility.

Next, in step 403, customized HDL functional blocks based on the user's input and the existing library of functions specified in step 402 are created.

In step 404, the design hierarchy is determined based on the user's input and the aforementioned library files. A hierarchy file, new library file, and makefile are subsequently generated based on the design hierarchy. The term “makefile” as used herein refers to the commonly used UNIX makefile function or similar function of a computer system well known to those of skill in the computer programming arts. The makefile function causes other programs or algorithms resident in the computer system to be executed in the specified order. In addition, it further specifies the names or locations of data files and other information necessary to the successful operation of the specified programs. It is noted, however, that the invention disclosed herein may utilize file structures other than the “makefile” type to produce the desired functionality.

In one embodiment of the makefile generation process of the present invention, the user is interactively asked via display prompts to input information relating to the desired design such as the type of “build” (e.g., overall device or system configuration), width of the external memory system data bus, different types of extensions, cache type/size, etc. Many other configurations and sources of input information may be used, however, consistent with the invention.

In step 406, the makefile generated in step 404 is run to create the structural HDL. This structural HDL ties the discrete functional block in the design together so as to make a complete design.

Next, in step 408, the script generated in step 406 is run to create a makefile for the simulator. The script to generate a synthesis script is also run in step 408.

At this point in the program, a decision is made whether to synthesize or simulate the design (step 410). If simulation is chosen, the user runs the simulation using the generated design and simulation makefile (and user program) in step 412. Alternatively, if synthesis is chosen, the user runs the synthesis using the synthesis script(s) and generated design in step 414. After completion of the synthesis/simulation scripts, the adequacy of the design is evaluated in step 416. For example, a synthesis engine may create a specific physical layout of the design that meets the performance criteria of the overall design process yet does not meet the die size requirements. In this case, the designer will make changes to the control files, libraries, or other elements that can affect the die size. The resulting set of design information is then used to re-run the synthesis script.

If the generated design is acceptable, the design process is completed. If the design is not acceptable, the process steps beginning with step 402 are re-performed until an acceptable design is achieved. In this fashion, the method 400 is iterative.

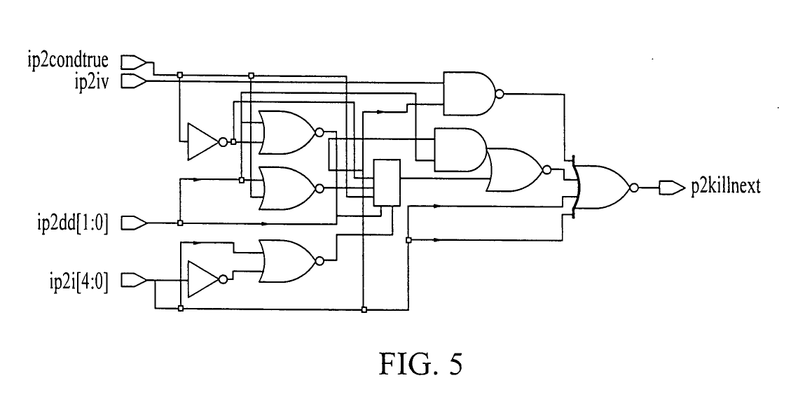

Referring now to FIG. 5, a first embodiment of exemplary gate logic (including the ip2bch signal referenced in the VHDL of Appendix A) synthesized using the aforementioned Synopsys® Design Compiler and methodology of FIG. 4 is illustrated. Note that during the synthesis process used to generate the logic of FIG. 5, an LSI 10 k 1.0 um process was specified, and no constraints were placed on the design. The p2killnext signal output from the logic of FIG. 5 is used elsewhere in VHDL code (rctl.vhdl) to mark the instruction in stage 1 as “killed” as it passes into stage 2.

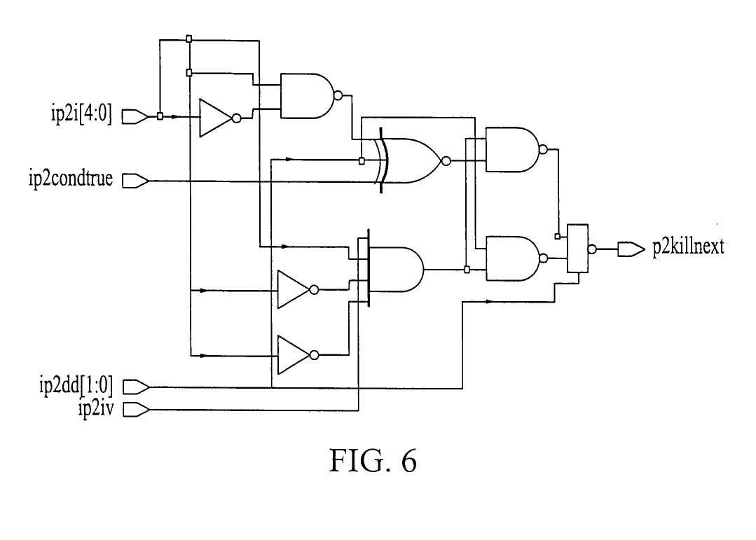

FIG. 6 illustrates a second embodiment of exemplary gate logic synthesized using the Synopsys® Design Compiler and the aforementioned 1.0 um process. Unlike the logic of FIG. 5, however, the critical path between ip2condtrue and p2killnext has been constrained to operate in the shortest possible time. As previously noted, a wide variety of other constraints may be applied during synthesis as desired.

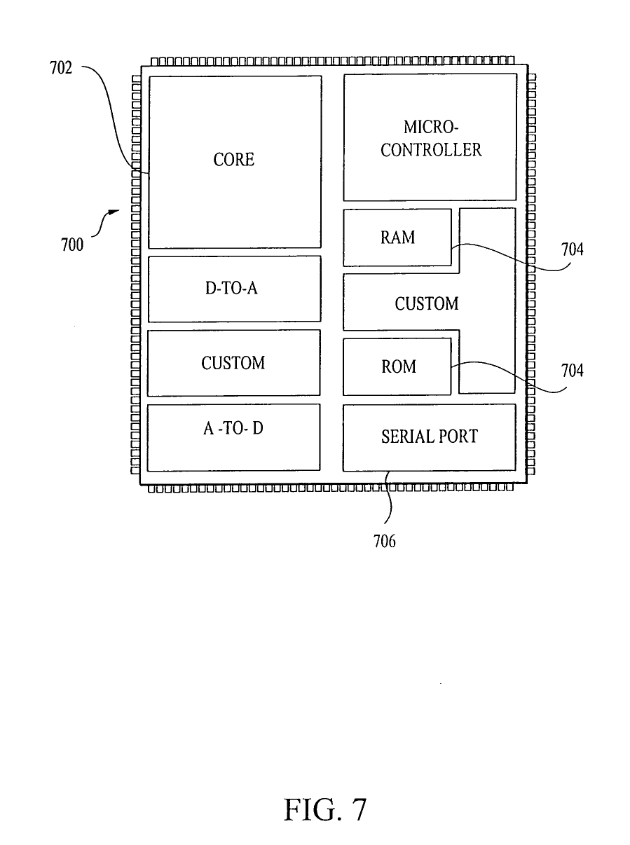

FIG. 7 illustrates an exemplary pipelined processor fabricated using a 1.0 um process and incorporating the logic of FIG. 5 and the jump delay slot modes previously described herein. As shown in FIG. 7, the processor 700 is an ARC microprocessor-like CPU device having, inter alia, a processor core 702, on-chip memory 704, and an external interface 706. The device is fabricated using the customized VHDL design obtained using the method 400 of the present invention, which is subsequently synthesized into a logic level representation, and then reduced to a physical device using compilation, layout and fabrication techniques well known in the semiconductor arts.

It will be appreciated by one skilled in the art that the processor of FIG. 7 may contain any commonly available peripheral such as serial communications devices, parallel ports, timers, counters, high current drivers, analog to digital (A/D) converters, digital to analog converters (D/A), interrupt processors, LCD drivers, memories and other similar devices. Further, the processor may also include custom or application specific circuitry. The present invention is not limited to the type, number or complexity of peripherals and other circuitry that may be combined using the method and apparatus. Rather, any limitations are imposed by the physical capacity of the extant semiconductor processes which improve over time. Therefore it is anticipated that the complexity and degree of integration possible employing the present invention will further increase as semiconductor processes improve.

It is also noted that many IC designs currently use a microprocessor core and a DSP core. The DSP however, might only be required for a limited number of DSP functions, or for the IC's fast DMA architecture. The invention disclosed herein can support many DSP instruction functions, and its fast local RAM system gives immediate access to data. Appreciable cost savings may be realized by using the methods disclosed herein for both the CPU & DSP functions of the IC.

Additionally, it will be noted that the methodology (and associated computer program) as previously described herein can readily be adapted to newer manufacturing technologies, such as 0.18 or 0.1 micron processes, with a comparatively simple re-synthesis instead of the lengthy and expensive process typically required to adapt such technologies using “hard” macro prior art systems.

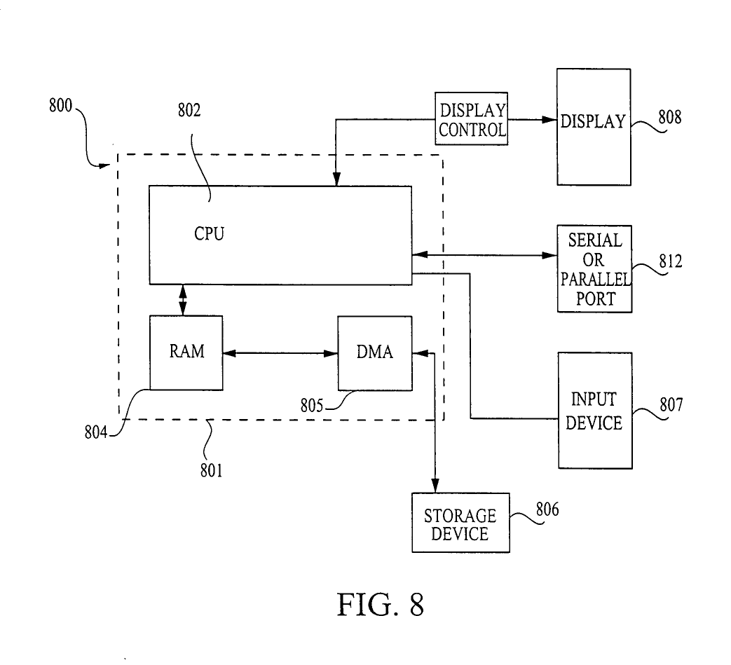

Referring now to FIG. 8, one embodiment of a computing device capable of synthesizing, inter alia, the jump delay mode logic structures of FIGS. 5 and 6 herein is described. The computing device 800 comprises a motherboard 801 having a central processing unit (CPU) 802, random access memory-(RAM) 804, and memory controller 805. A storage device 806 (such as a hard disk drive or CD-ROM), input device 807 (such as a keyboard or mouse), and display device 808 (such as a CRT, plasma, or TFT display), as well as buses necessary to support the operation of the host and peripheral components, are also provided. The aforementioned VHDL descriptions and synthesis engine are stored in the form of an object code representation of a computer program in the RAM 804 and/or storage device 806 for use by the CPU 802 during design synthesis, the latter being well known in the computing arts. The user (not shown) synthesizes logic designs by inputting design configuration specifications into the synthesis program via the program displays and the input device 807 during system operation. Synthesized designs generated by the program are stored in the storage device 806 for later retrieval, displayed on the graphic display device 808, or output to an external device such as a printer, data storage unit, other peripheral component via a serial or parallel port 812 if desired.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

APPENDIX A
EXEMPLARY DELAY SLOT VHDL USED FOR SYNTHESIS

library ieee.arc;
use ieee.std_logic_1164.all;
use arc.arcutil.all;
entity delay_slot is:

| | | | | |
|---|---|---|---|---|
| PORT( | ip2iv | ; | in | std_ulogic; |
| | ip2condtrue | ; | in | std_ulogic; |
| | ip2i | ; | in | std_ulogic_vector(4 downto 0); |
| | ip2dd | ; | in | std_ulogic_vector(1 downto 0); |
| | p2killnext | ; | out | std_ulogic); |

end delay_slot;
architecture synthesis of delay_slot is:

| | | | |
|---|---|---|---|
| signal | ip2bch | ; | std_ulogic; |
| signal | ip2rjmp | ; | std_ulogic; |
| signal | ip2lpcc | ; | std_ulogic; |
| signal | ip2jumping | ; | std_ulogic; |
| signal | ip2nojump | ; | std_ulogic; |
| signal | ip2killnext | ; | std_ulogic; |

begin

| | | | |
|---|---|---|---|
| ip2bch <= | ‘1’ WHEN ip2iv = ‘1’ | AND | (ip2i = obcc OR ip2i = oblcc |
| | | OR | ip2i = olpcc OR ip2i = |

ojcc ) ELSE

‘0’;

------ Delay slot canceling logic. ------
-- Due to the fact that the LPcc instruction uses its condition code in a
different way to the other branch instruction, two signals are required in the illustrated
embodiment to specify a jump instruction which is jumping, and one for specifying a jump
instruction which is not.
-- regular jump instruction --

| | | | | | |
|---|---|---|---|---|---|
| ip2rjmp | <= ‘1’ WHEN ip2iv = ‘1’ | AND | (ip2i | = | obcc |
| | | OR | ip2i | = | oblcc |
| | | OR | ip2i | = | ojcc ) ELSE |

-- loop setup instruction --

| | | | | | |
|---|---|---|---|---|---|
| ip2lpcc | <= ‘1’ WHEN ip2iv = ‘1’ | AND | (ip2i | = | olpcc) ELSE |

‘0’;
-- jumping/not jumping signals --

| | |
|---|---|
| ip2jumping | <= (ip2rjmp AND ip2condtrue) OR (ip2lpcc AND NOT |

ip2condtrue);

| | |
|---|---|
| ip2nojump | <= (ip2rjmp AND NOT ip2condtrue) OR (ip2lpcc AND |

ip2condtrue);
-- the kill signal itself --
--
-- ip2killnext include p2iv and a full decode for a jump, so can
-- be used in pipect1 without any further decode (apart from en2 of course).

| | | |
|---|---|---|
| ip2killnext<= ‘1’ | WHEN | ((ip2dd = dmk ) AND ip2bch = ‘1’) |
| | OR | ((ip2dd = dmnd) AND ip2jumping = ‘1’) |
| | OR | ((ip2dd = dmjd) AND ip2nojump = ‘1’) |

ELSE

‘0’;

p2killnext <= ip2killnext;

end synthesis;

APPENDIX B
EXEMPLARY SYNTHESIS SCRIPT USED FOR
DELAY SLOT SYNTHESIS

| /* produce result without any optimization */ | | | |
|---|---|---|---|
| /* assuming using the LSI Logic 10k library */ | | | |
| analyze - format vhdl - lib ARC | | | |
| {ARCHOME + “/arc/vhdl/arcutil.vhdl”} | | | |
| analyze - format vhdl - lib USER | | | |
| {USERDIR + “/vhdl/delay_slot.vhdl”} | | | |
| elaborate delay_slot -arch “synthesis” - lib USER | | | |
| compile | | | |
| write - format db - hierarchy -output db/delay_slot_noopt.db | | | |
| remove_design -all | | | |
| /* result with logic optimization */ | | | |
| elaborate delay_slot -arch “synthesis” -lib USER | | | |
| /* timing for inputs direct from flipflops */ | | | |
| t_in = 1.33 | | | |
| /* create an imaginary 20MHz clock */ | | | |
| create_clock -name ck -period 50 | | | |
| set_input_delay | 20 | ip2condtrue | -clock ck |
| set_input_delay | t_in | ip2dd | -clock ck |
| set_input_delay | t_in | ip2l | -clock ck |
| set_input_delay | t_in | ip2iv | -clock ck |
| set_output_delay | 28 | p2killnext | -clock ck |

compile
write -format db -hierarchy -output db/delay_slot_opt.db

1.-24. (canceled)

25. A user-extended and user-customized digital RISC processor having a pipeline, and an instruction set comprising a plurality of instructions comprising a base instruction set and at least one extension instruction, said at least one extension instruction having associated extension hardware, at least one of said base instruction set instructions or extension instructions comprising a branch instruction having a plurality of user-configurable modes determined by a plurality of bits within an instruction word (IW) controlling the execution of at least one instruction in a delay slot following said branch instruction within said pipeline, each of said modes being constrained to only one of a plurality of unique combinations of said plurality of bits.

26. The processor of claim 25, wherein said plurality of bits comprise two bits defining four discrete modes controlling the execution of at least one instruction in a delay slot following said branch instruction within said pipeline;
wherein said execution is controlled without regard to a branch direction metric.

27. The processor of claim 26, wherein each of said four modes provides unique functionality with respect to the other three modes.

28. The processor of claim 25, wherein said bits are encoded in said branch instruction, and said bits of said branch instruction comprise two data bits defining four discrete modes controlling said execution, said execution further being controlled without regard to a branch direction metric.

29. The processor of claim 25, wherein said bits are encoded in said branch instruction, and at least one of said unique combinations of said bits of said branch instruction and a logical function associated therewith are adapted for assignment by a user.

30. The processor of claim 29, wherein at least one of said unique combinations of said bits of said branch instruction and a logical function associated therewith are adapted for assignment by a user.

31. An extended digital RISC processor having a pipeline and an instruction set, said processor comprising:
a user-customized processor core rendered in a hardware description language model and including a base instruction set; and
at least one user-configured extension instruction within said instruction set, said at least one extension instruction being selected by a user before generation of said model and comprising a branch instruction having at least one mode controlling the execution of at least one instruction in a delay slot following said branch instruction within said pipeline using a plurality of data bits, at least one particular combination of data bits and a logical function associated therewith being adapted for assignment by a user.

32. A user-customized and user-extended processor core having at least one pipeline comprising at least instruction fetch, decode, execute and write-back stages, and an associated data storage device, wherein the execution of instructions within said at least one pipeline is controlled by the method comprising:
storing an instruction set within said data storage device, said instruction set comprising a plurality of instruction words, each of said instruction words comprising a plurality of data bits, at least one of said instruction words comprising a user-configurable branch instruction having a plurality of unique functional modes exclusively associated with respective ones of unique combinations of a plurality of mode control bits, said branch instruction directing branching to a first address within said data storage device;
assigning one of a plurality of values to each of said mode control bits of said at least one branch instruction;
decoding said at least one branch instruction including said assigned values;
determining whether to execute an instruction within said pipeline in a stage preceding that of said at least one branch instruction based at least in part on said assigned values;
branching to said first address based on said at least one branching instruction; and
performing, based at least in part on decoding said assigned values, at least one other function dictated by the unique functional mode associated with said assigned values;
wherein said processor core has a configuration determined at least in part by said user-customization and user-extension at the time of its design.

33. A method of controlling the execution of instructions within an extended and user-customized RISC processor having a pipeline, said processor further being generated from a hardware description language model, comprising:
providing, as part of said description language model, an instruction set comprising a plurality of instruction words, each of said instruction words comprising a plurality of data bits, at least one of said words comprising a jump instruction having at least one user-configurable mode and at least one user-definable mode associated therewith, said user-configurable and user-definable modes each being specified by the same ones of said plurality of data bits, said at least one user-definable mode not being predetermined in terms of function;
assigning one of a plurality of values to said ones of said data bits of said at least one jump instruction; and
controlling the execution of at least one subsequent instruction within said pipeline based on said one assigned value of said ones of data bits when said at least one jump instruction is decoded;
wherein said method further comprises generating a long immediate constant using a single word instruction by:
providing an instruction word having an op-code and at least one short immediate value associated therewith, said at least one short immediate value comprising a plurality of bits;
selecting a portion of said plurality of bits of said at least one short immediate value;
shifting all of said bits of said at least one short immediate value using said op-code and only said portion of bits to produce a shifted immediate value; and
storing said shifted immediate value in a register.

34. A user-extended and user-customized digital RISC processor core having a pipeline, and an instruction set comprising a plurality of instructions comprising a base instruction set and at least one extension instruction, at least one of said base instruction set instructions or extension instructions comprising a branch instruction having a plurality of user-configurable modes, said modes being determined by a plurality of bits controlling the execution of at least one instruction in a delay slot following said branch instruction within said pipeline, each of said modes being constrained to only one of a plurality of unique combinations of said plurality of bits;
wherein said processor core is user-customized by at least:
receiving one or more inputs from a user for at least one customized parameter of said processor; and
generating through an automated process a customized description language model of said core based on the least one customized parameter.

35. The processor core of claim 34, wherein said automated process comprises modifying at least one prototype description by substituting values in the at least one prototype description or merging additional descriptions based on the at least one customized parameter.

36. The processor core of claim 34, wherein said processor core is further user-customized by generating, through an automated process, test code associated with the customized description language model based on the at least one customized parameter; and

37. The processor core of claim 34, wherein the customized description language model includes both functional and structural description language descriptions for the processor core.

38. An extended and user-customized digital RISC processor having a pipeline and an instruction set, said processor comprising:
a processor core configuration including a base instruction set; and
at least one user-configured extension instruction within said instruction set, said at least one extension instruction comprising a branch instruction having at least one mode controlling the execution of at least one instruction in a delay slot following said branch instruction within said pipeline using a plurality of data bits within an instruction word, at least one particular combination of data bits and a logical function associated therewith being adapted for assignment by a user;
wherein said processor core configuration is user-customized by at least:
receiving one or more inputs from a user for at least one customized parameter of said processor; and
generating through an automated process a customized description language model of said core based at least in part on the least one customized parameter.

39. The processor of claim 38, wherein said automated process comprises modifying at least one prototype description by substituting values in the at least one prototype description or merging additional descriptions based on the at least one customized parameter.

40. The processor of claim 38, wherein said processor core is further user-customized by generating, through an automated process, test code associated with the customized description language model based on the at least one customized parameter; and

41. The processor of claim 38, wherein the customized description language model includes both functional and structural description language descriptions for the processor core.

42. An extensible and user-customizable digital processor design having a multi-stage pipeline and base and extension instruction sets operative thereon, at least one instruction within said base set comprising a branch instruction having four discrete user-selectable modes for controlling the execution of at least one instruction in a delay slot following said branch instruction within said pipeline, said processor design comprising:
a processor core configuration including said base instruction set; and
at least one user-customized extension instruction within said extension instruction set;
wherein each of said modes provides unique functionality with respect to the other three modes; and
wherein said processor core configuration is user-customized by at least:
receiving one or more inputs from a user for at least one customized parameter of said processor; and
generating through an automated process a customized description language model of said core configuration based at least in part on the least one customized parameter.

43. The processor design of claim 42, wherein said automated process comprises modifying at least one prototype description by substituting values in the at least one prototype description or merging additional descriptions based on the at least one customized parameter.

44. The processor design of claim 42, wherein said processor core configuration is further user-customized by generating, through an automated process, test code associated with the customized description language model based on the at least one customized parameter; and

45. The processor design of claim 42, wherein the customized description language model includes both functional and structural description language descriptions for the processor core configuration.

46. The processor design of claim 42, wherein said automated process comprises modifying at least one template description by substituting values in the at least one template description or merging additional descriptions based on the at least one customized parameter.
